(19) United States
(12) Patent Application Publication
(10) Pub. No.: US 2026/0237101 A1
(43) Pub. Date: Aug. 13, 2026

(54) SYSTEMS AND METHOD FOR ENCODING AND DECODING PARAMETERS OF A MACHINE LEARNING MODEL

(71) Applicant: GUANGDONG OPPO MOBILE TELECOMMUNICATIONS CORP., LTD., Dongguan (CN)

(72) Inventors: Olgierd STANKIEWICZ, Poznan (PL); Marek DOMANSKI, Poznan (PL); Tomasz GRAJEK, Poznan (PL); Slawomir MACKOWIAK, Poznan (PL); Slawomir ROZEK, Poznan (PL); Jakub STANKOWSKI, Poznan (PL); Maciej WAWRZYNIAK, Poznan (PL)

(73) Assignee: GUANGDONG OPPO MOBILE TELECOMMUNICATIONS CORP., LTD., Dongguan (CN)

(21) Appl. No.: 19/639,907

(22) Filed: Apr. 6, 2026

Related U.S. Application Data
(63) Continuation of application No. PCT/CN2024/123493, filed on Oct. 8, 2024.

(30) Foreign Application Priority Data
Oct. 9, 2023 (EP) 23461660.5

(51) Int. Cl. G06T 9/00; G06F 5/01; G06N 20/00; G06T 7/70

(52) U.S. Cl. CPC G06T 9/00; G06F 5/012; G06N 20/00; G06T 7/70

(57) ABSTRACT

A method for decoding parameters of a machine learning model is provided. The method includes that: a bitstream is decoded to determine values of samples in an image data; one or more parameter values are determined based on the values of the samples in the image data; and one or more parameters of the machine learning model are determined based upon the one or more parameter values.

### CROSS-REFERENCE TO RELATED APPLICATIONS

This is a continuation application of International Patent Application No. PCT/CN2024/123493, filed on Oct. 8, 2024, which claims priority to European Patent Application No. 23461660.5, filed on Oct. 9, 2023, the contents of which are hereby incorporated by reference in their entireties.

### BACKGROUND

Machine learning models are now widespread in their use. In particular, neural networks are one popular type of machine learning model. Current neural networks can have millions or even billions of parameters and are ever-increasing in size. Typically, large neural networks are trained on computing systems with large amounts of computational resources. Once trained, the neural network may be transmitted to user devices for deployment. Given the number of parameters and size of these neural networks, there is a need for efficient methods for transmitting and storing parameters of neural networks and other machine learning models in general.

### SUMMARY

The present disclosure relates to the field of machine learning, more particularly to methods and systems for encoding and decoding parameters of a machine learning model for transmittal or storage.

According to a first aspect there is provided a method for decoding parameters of a machine learning model. The method includes that: a bitstream is decoded to determine values of samples in an image data; one or more parameter values are determined based on the values of the samples in the image data; and one or more parameters of the machine learning model are determined based upon the one or more parameter values.

According to a second aspect, a method for encoding parameters of a machine learning model is provided. The method includes that: one or more parameters of a machine learning model are obtained; one or more parameter values are determined based on the one or more parameters of the machine learning model; values of samples in an image data are determined based on the one or more parameter values; and the image data is encoded to generate a bitstream.

According to a third aspect, there is provided a device for decoding parameters of a machine learning model, which includes one or more processors and a computer-readable storage medium storing computer executable instructions. The computer executable instructions, when executed by the one or more processors, cause the one or more processors to: decode the bitstream to determine values of samples in an image data; determine the one or more parameter values based on the values of the samples in the image data; and determine one or more parameters of the machine learning model based upon the one or more parameter values.

These and other aspects of the present disclosure may become more readily apparent from the following description of the embodiments.

### BRIEF DESCRIPTION OF THE DRAWINGS

Embodiments will now be described, by way of example only, with reference to the accompanying drawings, in which:

FIG. 1 shows a flowchart of decoding operations according to an embodiment;

FIG. 2 shows a flowchart of encoding operations according to an embodiment;

FIG. 3 shows a flowchart for transmitting parameters of a machine learning model according to an embodiment;

FIG. 4 shows a block diagram illustrating an example encoding system according to an embodiment;

FIG. 5 shows a block diagram illustrating an example decoding system according to an embodiment;

FIG. 6 shows a schematic illustration of a layer of a neural network;

FIG. 7 shows a schematic illustration of an example decoder according to various embodiments;

FIG. 8 shows a schematic illustration of an example encoder according to various embodiments; and

FIG. 9 shows a schematic illustration of example encoder and decoder computing devices according to various embodiments.

### DETAILED DESCRIPTION

Technical solutions in the embodiments of the present disclosure will be described clearly and completely below with reference to the accompanying drawings.

An “encoder” is a device capable of encoding data into a bitstream, while a “decoder” is a device capable of decoding the bitstream in order to obtain the encoded data, or an approximation of the encoded data. A “bitstream” includes a sequence of bits.

“Image data” as used herein includes a single picture, which may also be referred to as an “image frame”, or a plurality of pictures or “image frames”. The term “image data” as used herein also includes video data given that video data includes a plurality of pictures/image frames.

Machine learning models may be transmitted from one computing device to another. For example, a machine learning model may be trained on a computing system with a large amount of computational resources and be transmitted to other computing devices, such as user devices, for deployment. In another example, the computing devices may be part of distributed system for training the machine learning model. The computing devices may transmit the machine learning model between one another to synchronize the models during training. The size of machine learning models can be very large, on the order of millions or billions of parameters in some cases. Transmitting and storing such models requires a large amount of bandwidth, memory and storage.

In the techniques described herein, the parameters of a machine learning model are represented as (e.g., converted into, or mapped to) an image data, and the image data is coded using image or video compression algorithms. The coded image data is smaller in size than the original size of the parameters and hence the amount of bandwidth required to transmit the parameters and the amount of memory or storage required for storing the parameters of the machine learning model can be greatly reduced. The receiving computing device can decode the coded image data to reconstruct the parameters of the machine learning model.

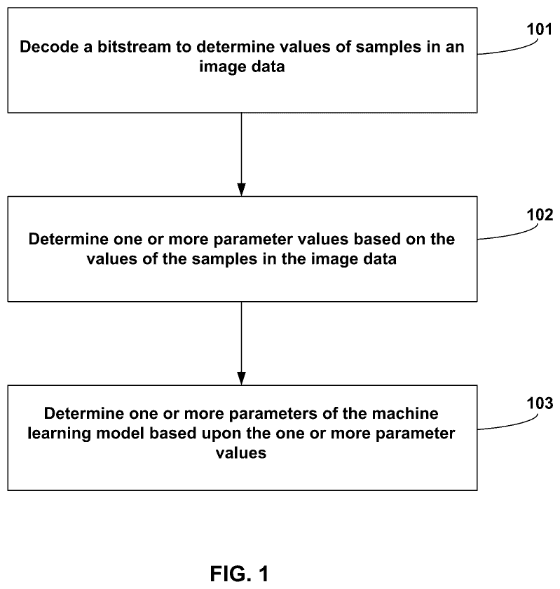

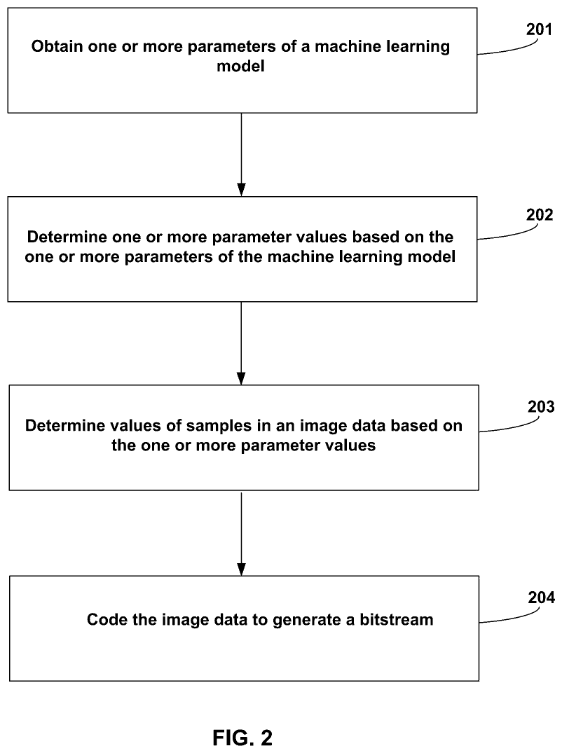

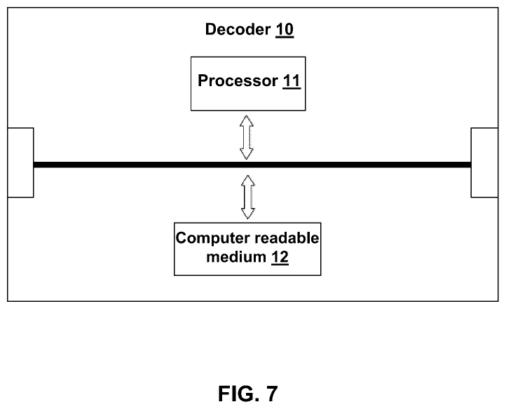

FIG. 1 shows a flowchart of decoding operations according to an embodiment. FIG. 2 shows a flowchart of corresponding encoding operations. The operations of FIG. 1 may be implemented by one or more processors in one or more locations. For example, the operations of FIG. 1 may be implemented by a decoder 10 shown in FIG. 7.

The flowchart of FIG. 1 starts at step 101, in which a bitstream is decoded to determine values of samples in an image data. The image data represents one or more parameter values for a machine learning model. The bitstream may be obtained from a remote computing device via a network connection. In alternative embodiments, or the image data may be obtained from a local storage device or memory.

In general, the bitstream is decoded according to the particular compression algorithm used to code the image data. The image data may be coded using any suitable image or video compression algorithm and may be coded according to any image or video file format. The compression algorithm may be a lossless or lossy compression algorithm. In one example, the image data is coded according to the PNG image format. Other suitable image formats include JPEG or WebP. In another example, the image data is coded based upon the H.265/HEVC algorithm. In a further example, the image data is coded based upon the H.266/VVC algorithm. Other suitable algorithms include H.264/AVC, VP9, AV1, or an AVS-based algorithm. Embodiments are not limited to any particular compression algorithm or format.

The machine learning model may be any type of machine learning model such as a neural network, support vector machine, decision tree, random forest, linear regression, k-means clustering, reinforcement learning system amongst others. The machine learning model may be applied to any type of task such as image recognition, object detection, image segmentation, image captioning, tracking of objects in video, action recognition, speech recognition, speaker detection, natural language processing, question answering, control of an autonomous vehicle or electro-mechanical agent amongst others. Embodiments are not limited to any particular machine learning model or application of the machine learning model.

At step 102, one or more parameter values are determined based on the values of the samples in the image data. The values of the samples in the image data may be mapped from a sample value range to a parameter value range used by the machine learning model. This mapping may be carried out on the decompressed image data. A “sample” of the image data may be a “pixel” of the image data.

In one example, determining the one or more parameters may be based upon a bit-depth associated with the image data. For example, the bit-depth may be 8-bits and the sample values of the image data may be in the range 0 to 255. The original range of the parameter values may be different to the sample value range and the determining may include mapping samples values from the sample value range to the parameter value range. Data indicating the parameter value range may be included in the image data for coding or may be coded separately. It will be appreciated that embodiments are not limited to an 8-bit bit-depth and any suitable bit-depth and parameter value range may be used.

A correspondence between samples and parameters may be determined as part of step 102. That is, step 102 may include determining a spatial location of one of the samples in the image data, and determining one of the parameter values based on the spatial location and the value of the sample in the image data. Specifically, step 102 may include determining one of the parameter values by mapping between the value of one of the samples in the image data and the parameter value based on the spatial location of the sample in the image data. For example, a mapping between spatial locations of samples in the image data and parameter indices identifying the one or more parameters is determined. In one example, the machine learning model is a neural network and the one or more parameters include the weights of one particular layer of the neural network. A weight may be associated with an edge that connects a unit in a first layer to a unit in a second layer. The weight may be identified using a tuple having a first value indexing the unit of the first layer and a second value indexing the unit of the second layer. A sample of the image data may be identified by its spatial co-ordinate. A mapping may be determined to map between sample co-ordinates and parameter indices to establish which values of the image data correspond to which parameters of the machine learning model. In one example, a direct correspondence may be used where the parameters can be indexed by two integer values and treated as co-ordinate values in the image data. In other examples, a further transformation may be required to be convert from sample co-ordinates to parameter indices or vice-versa.

It will be appreciated that embodiments are not limited to sample co-ordinates and other types of spatial location may be used such as a block or region of the image data. This may be the case where the compression algorithm uses coding blocks. In one example, the mapping is based upon a coding block size.

At step 103, one or more parameters of a machine learning model are determined based upon the one or more parameter values obtained from step 102. For example, a parameter may be determined according to the sample value at the determined corresponding spatial location of the image data for the parameter, the sample value converted to the parameter value range.

In one example, the machine learning model may be an existing machine learning model and the one or more parameter values specify an update to some or all of the parameters of the existing machine learning model. In another example, a machine learning model may be created using the one or more parameter values obtained from step 102. The image data may also represent the architecture, activation function choices or other hyperparameters for creating the machine learning model or such data may be obtained separately. In some cases, the architecture can be inferred from the image data, for example, the size of a layer of a neural network may be inferred from the dimensions of the image data. The image data may represent the parameters for separate layers of the neural network in separate pictures or channels. Thus, in one example, the image data may include a first picture or channel representing one or more parameters of a first layer of the neural network and a second picture or channel representing one or more parameters of a second layer of the neural network. However, embodiments are not limited to any particular example.

In one example, the one or more parameter values are floating point numbers comprising a sign-bit, an exponent and a mantissa. The image data may include a dedicated picture or channel for representing the sign-bits of the one or more parameters, and/or the image data may include a dedicated picture or channel for representing the exponents of the one or more parameters, and/or the image data may include a dedicated picture or channel for representing the mantissas of the one or more parameters. The pictures or channels may be each be decoded to reconstruct the sign-bits, exponents and mantissas as appropriate. A more detailed example is described below.

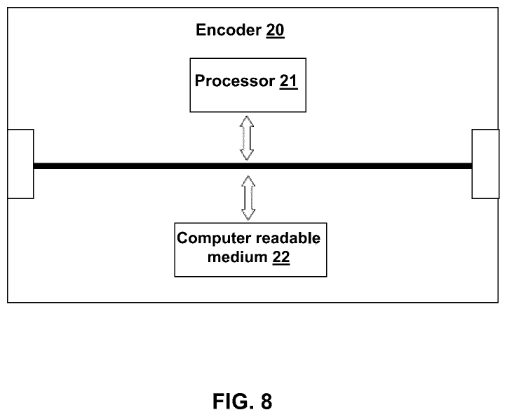

FIG. 2 shows a flowchart of corresponding encoding operations to that of FIG. 1. The operations of FIG. 2 may be implemented by one or more processors in one or more locations. For example, the operations of FIG. 2 may be implemented by an encoder 20 as shown in FIG. 8.

At step 201, one or more parameters of a machine learning model are obtained. The parameters may be a subset of the parameters of the machine learning model. For example, the parameters may be the parameters of a single layer of a neural network or the parameters of certain particular layers. The parameters may include only the weights of a neural network without the biases or only the biases without the weights. Alternatively, all of the parameters of the machine learning model may be obtained.

The machine learning model may be any type of machine learning model such as a neural network, support vector machine, decision tree, random forest, linear regression, k-means clustering, reinforcement learning system amongst others. The machine learning model may be applied to any type of task such as image recognition, object detection, image segmentation, image captioning, tracking of objects in video, action recognition, speech recognition, speaker detection, natural language processing, question answering, control of an autonomous vehicle or electro-mechanical agent amongst others. Embodiments are not limited to any particular machine learning model or application of the machine learning model.

At step 202, one or more parameter values are determined based on the one or more parameters of the machine learning model obtained at step 201.

At step 203, values of samples in an image data are determined based on the one or more parameter values. Specifically, there may be a mapping between the one or more parameter values and the values of samples in the image data. In other words, the one or more parameter values are mapped from a parameter value range to a sample value range, to obtain the values of samples in the image data.

The determining (step 203) may be based upon a target bit-depth. The target bit-depth may be pre-determined or supplied by a user. In one example, the target bit-depth is 8-bits with sample values in the range 0 to 255. The one or more parameters may have values in a different range and the determining may include mapping parameter values from the parameter value range to the sample value range to produce corresponding sample values for each parameter. Data indicating the parameter value range may be determined in the generated image data or provided as separate data for use in decoding. It will be appreciated that other bit-depths may be used such as 10-bits, 12-bits or any other suitable bit-depth.

Before step 203, the method may further include determining a spatial location of one of the samples in the image data. Step 203 may include determining a value of the sample in the image data by mapping between the value of the sample in the image data and one of the parameter values based on the spatial location of the sample in the image data. For example, determining the spatial location of one of the samples in the image data may include determining a mapping between spatial locations of samples in the image data and parameter indices identifying the one or more parameters. As discussed above, in one example, the machine learning model is a neural network and the one or more parameters include the weights of one particular layer of the neural network. A weight may be associated with an edge that connects a unit in a first layer to a unit in a second layer. The weight may be identified using a tuple having a first value indexing the unit of the first layer and a second value indexing the unit of the second layer. A sample of the image data may be identified by its spatial co-ordinate. A mapping may be determined to map between sample co-ordinates and parameter indices to establish where a parameter's value should be determined in the image data. In one example, a direct correspondence may be used where the parameters can be indexed by two integer values and treated as co-ordinate values in the image data. In other examples, a further transformation may be required to be convert from parameter indices to sample co-ordinates and vice-versa.

In one example, initial image data comprising sample values is generated by mapping parameter values to sample values and storing the sample values at the determined spatial locations in the initial image data corresponding to the parameter. An image or video compression algorithm is applied to the initial image data to generate output coded image data for transmission or storage. However, embodiments are not limited to this particular example.

It will also be appreciated that embodiments are not limited to sample co-ordinates and other types of spatial location may be used such as a block or region of the image data. This may be the case where the compression algorithm uses coding blocks. In one example, the mapping is based upon a coding block size.

In one example, the one or more parameter values are floating point numbers comprising a sign-bit, an exponent and a mantissa. The generated image data may include a dedicated picture or channel used for representing the sign-bits of the one or more parameters, and/or the image data may include a dedicated picture or channel used for representing the exponents of the one or more parameters, and/or the image may include a dedicated picture or channel used for representing the mantissas of the one or more parameters. A more detailed example is described below.

In one example, the machine learning model may be a neural network and the image data represents the parameters for separate layers of the neural network in separate pictures or channels. Thus, the image data may include a first picture or channel representing one or more parameters of a first layer of the neural network and a second picture or channel representing one or more parameters of a second layer of the neural network. The image data may also represent the architecture, activation function choices or other hyperparameters for the machine learning model or such data may be represented separately. In some cases, the architecture can be inferred from the image data, for example, the size of a layer of a neural network may be inferred from the dimensions of the image data.

In one example, the machine learning model may be undergoing training. It may be useful to store the parameters of the machine learning model as training progresses. For example, to inspect how the parameters have evolved during training or to restore the parameters to a previous time step if training does not improve the machine learning model. In this regard, the image data may include a first temporal picture or channel representing first parameter values associated with a first time-step and a second temporal picture or channel representing second parameter values associated with a second time-step.

At step 204, the image data is coded to generate a bitstream. For example, the image data may be coded according to an image or video compression algorithm. As discussed above, any suitable image or video compression algorithm may be used for coding the image data. The image data may be coded using any suitable image or video file format. The compression algorithm may be a lossless or lossy compression algorithm. In one example, the image data is coded according to the PNG image format. Other suitable image formats include JPEG, and WebP. In another example, the image data is coded based upon the H.265/HEVC algorithm. In a further example, the image data is coded based upon the H.266/VVC algorithm. Other suitable compression algorithms include H.264/AVC, VP9, AV1, and an AVS-based algorithm. However, embodiments are not limited to any particular algorithm or format.

The bitstream may be transmitted to another computing device for reconstructing the one or more parameters. In addition, or alternatively, the bitstream may be stored at a local storage device for reconstructing the one or more parameters at a later time.

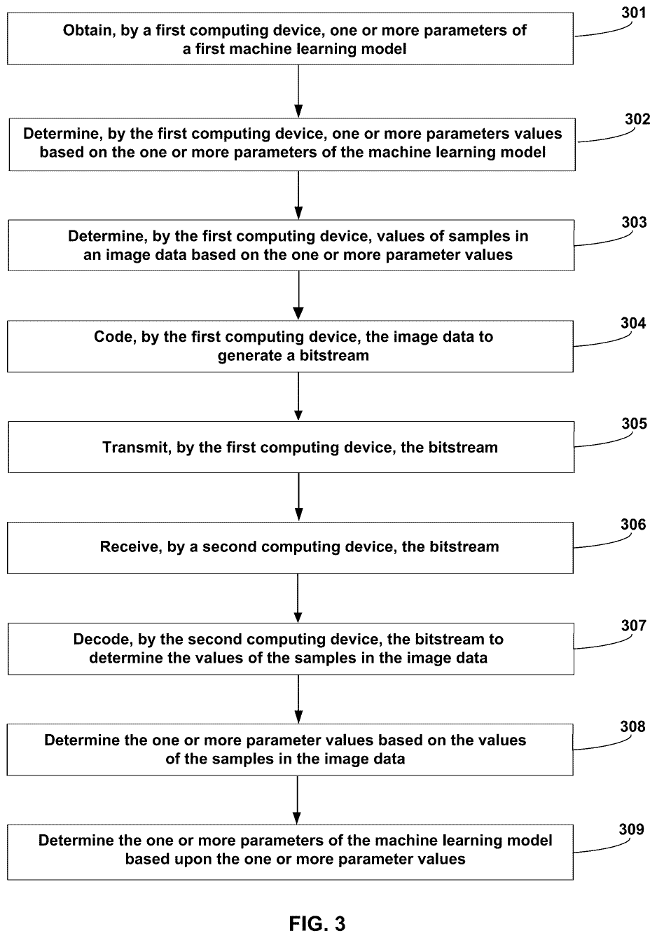

FIG. 3 is a flowchart that shows operations for transmitting parameters of a machine learning model. The flowchart of FIG. 3 starts at step 301 in which a first computing device obtains one or more parameters of a first machine learning model. The first computing device may be any type of computing device such as a server, desktop computer, a mobile device such as a laptop, smartphone or tablet, or any other suitable computing apparatus.

At step 302, the first computing device determines one or more parameters values based on the one or more parameters of the machine learning model.

At step 303, the first computing device determines values of samples in an image data based on the one or more parameter values.

At step 304, the first computing device codes the image data to generate a bitstream.

The above may be done according to the operations described above with respect to FIG. 2.

At step 305, the first computing device transmits the bitstream and at step 306, a second computing device receives the bitstream. The second computing device may be any type of computing device such as a server, desktop computer, a mobile device such as a laptop, smartphone or tablet, or any other suitable computing apparatus. The image data may be transmitted over any type of network connection such as a local area network (LAN), a wide area network (WAN) including the Internet or a cellular network.

At step 307, the second computing device decodes the bitstream to determine the values of the samples in the image data.

At step 308, the second computing device determines the one or more parameter values based on the values of the samples in the image data.

At step 309, the second computing device determines one or more parameters of the machine learning model based upon the one or more parameter values.

Steps 307-309 may be done according to the operations described above with respect to FIG. 1.

The second computing device determines one or more parameters of a second machine learning model corresponding to the one or more parameters of the first machine learning based upon the determined one or more parameter values. In one example, the transmission of parameters is for deploying a copy of the first machine learning model on the second computing device. As such, the second machine learning model is initialized with the same architecture/hyperpameters as the first machine learning model. Such data may be represented in the image data or may be transmitted separated or may pre-exist on the second computing device. The parameters of the second machine learning model may then be set based upon the determined parameter values to create a copy of the first machine learning model for deployment on the second computing device.

In another example, the transmission of the parameters may be for updating an existing copy of a machine learning model on the second computing device. For example, the first machine learning model may have undergone further training or fine-tuning. The second computing device may then update the corresponding parameters of the second machine learning model based upon the determined parameter values.

In a further example, the first and second computing devices may be part of a distributed training system for training the machine learning model. One or both of the first and second computing devices may train a copy (or copies) of the machine learning model. The transmission of parameter values may be for synchronizing the parameters of the machine learning models between the first and second computing devices during training.

It will be appreciated that embodiments are not limited to the particular examples described above.

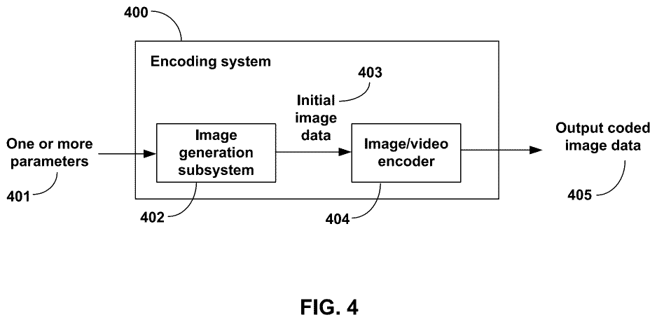

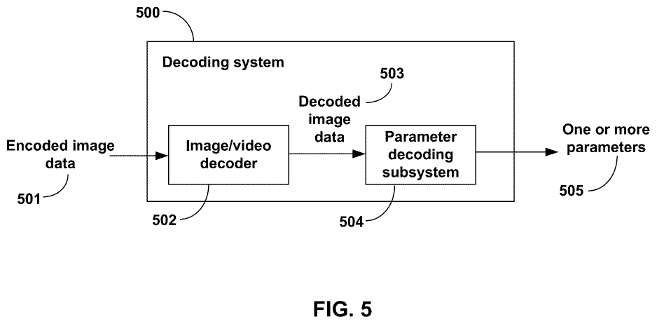

Specific encoding and decoding examples will now be described with reference to the example encoding system embodiment shown in FIG. 4 and example decoding system embodiment shown in FIG. 5. The example encoding and decoding systems may implement any of the operations discussed above with respect to FIGS. 1-3 as appropriate.

The encoding system 400 in FIG. 4 is configured to process input one or more parameters 401 of a machine learning model. The encoding system 400 includes an image generation subsystem 402 that is configured to generate initial image data 403 from the one or more parameter values 401. This may include mapping parameter values to sample values and/or determining a sample location at which to represent a parameter in the image data. The encoding system 400 further includes an image/video encoder 404 that is configured to encode the initial image data 403 using an image or video compression algorithm to generate output coded image data 405 for transmission or storage.

The decoding system 500 in FIG. 5 is configured to process input coded image data 501. The decoding system 500 includes an image/video decoder 502 that is configured to decode the coded image data 501 according to an appropriate image/video decompression algorithm to generate decoded image data 503. The decoding system 500 further includes a parameter decoding subsystem 504 that is configured to reconstruct the one or more parameters from the decoded image data 503. This may include mapping sample values to parameter values and/or determining a sample location at which a parameter is represented in the decoded image data 503. The parameter decoding subsystem 504 provides as output the one or more parameters 505 of a machine learning model that have been represented in the coded image data 501.

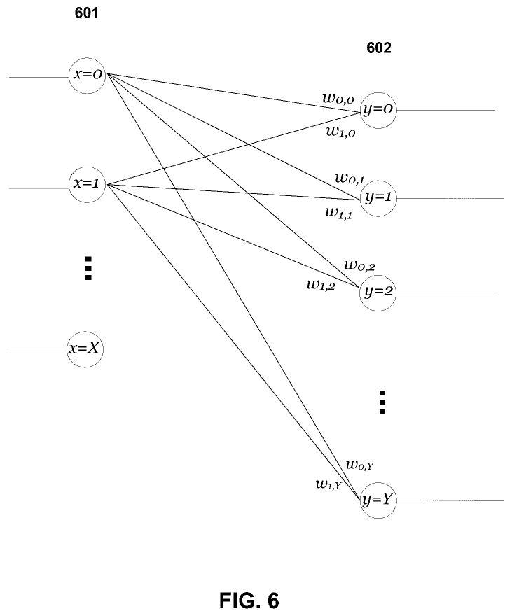

Three examples of parameter encoding and decoding will now be described. Each example uses the weights of a single layer of a neural network as the parameters and machine learning model respectively for illustrative purposes. However, it will be appreciated that embodiments are not so limited. As shown in FIG. 6, a weight is associated with a connection between a unit in a first layer 601 and a unit in a second layer 602. The units of the first layer 601 are indexed by x and the units of the second layer 602 are indexed by y. Each weight, w, is identified by the tuple x,y, that is the weight associated with the connection between unit x of the first layer 601 and unit y of the second layer 602. Thus, weight w_{1,2} represents the weight associated with the connection between unit x=1 of the first layer and unit y=2 of the second layer. There are a total of X units in the first layer 601 and Y units in the second layer 602. Some units and connections have been omitted from FIG. 6 for clarity.

In a first example, the weights range in value from wₘᵢₙ to wₘₐₓ. A target bit-depth of 8-bits is chosen which provides for sample values in range 0 to 255. For encoding, the weights are provided as input to the encoding system 400. The weight values are mapped from the range wₘᵢₙ to wₘₐₓ to 0 to 255 by the image generation subsystem 401. As the weights have a two-integer index, these can be used directly as sample co-ordinates for the image data. Thus, each sample with co-ordinates (x, y) of an initial image 403, V, may be generated as:

$$V [ x , y ] = round ( ( {w}_{x , y} - {w}_{min} * 25 \; 5 \text{.0} ) / ( {w}_{max} - {w}_{min} ) ) \qquad ( 1 )$$

where * denotes multiplication and round(⋅) provides the nearest integer value.

The initial image data 403, V is then coded using the PNG image format by the image/video encoder 404 to generate output coded image data 405. This is transmitted from a first computing device hosting the encoding system 400 to a second computing device together with weight value range wₘᵢₙ and wₘₐₓ.

The second computing device receives the coded image data 405/501 and provides this as input to the decoding system 500. The image/video decoder 502 decodes the coded image data 501 according to the PNG image format to produce decoded image data 503. The decoded image data 503 is then reversed mapped using the parameter decoding subsystem 504 to reconstruct the weights 505 as follows:

$${w}_{x , y} = ( V [ x , y ] / 255. ) * ( {w}_{max} - {w}_{min} ) + {w}_{min} \qquad ( 2 )$$

In a second example, the weights again range in value from wₘᵢₙ to wₘₐₓ and a target bit-depth of 8-bits is chosen. In this example however, the H.265/HEVC compression algorithm is used by the image/video encoder 404 with a CTU size of N×N. In this case, an initial image 403, V, is generated by the image generation subsystem 402 as follows:

$$V [ i , j ] = round ( ( {w}_{x , y} - {w}_{min} * 25 \; 5 \text{.0} ) / ( {w}_{max} - {w}_{min} ) ) \qquad ( 3 )$$

$$where$$

$$i = y // N ; and$$

$$j = y \% N + x * N ;$$

and // represents integer division (with rounding towards zero) and % represents the modulo operator. In this formulation, the first row of CTUs correspond to weights from unit x=0. Particular samples within a CTU correspond to zig-zag ordered weights leading to successive units y.

The initial image data 403, V, is then coded using the H.265/HEVC compression algorithm by the image/video encoder 404 to generate output coded image data 405. This is transmitted from the first computing device hosting the encoding system 400 to a second computing device. The weight value range wₘᵢₙ and wₘₐₓ is also transmitted to the second computing device. The CTU block size can also be transmitted or may be pre-agreed with the second computing device.

The second computing device receives the coded image data 405/501 and decompresses the coded image data 501 using the image/video decoder 502. The decompressed image data 503 is then reversed mapped using the parameter decoding subsystem 504 to reconstruct the weights 505 as follows:

$${w}_{x , y} = ( V [ i , j ] / 255. ) * ( {w}_{max} - {w}_{min} ) + {w}_{min} \qquad ( 4 )$$

In a third example, the weights are 32-bit floating point numbers represented according to the IEEE754 format. In this format, a weight value is represented as:

$${w}_{x , y} = {sign}_{x , y} * {2}^{⋀} ( {exponent}_{x , y} - 128 ) * ( 1 \cdot {mantissa}_{x , y} ) \qquad ( 5 )$$

with one bit used to represent the sign, eight bits used to represent the exponent and 23 bits used to represent the mantissa.

The sign-bits, exponents and mantissas are each represented in their own dedicated pictures. In this example, a target bit-depth of 8-bits is used for each picture. The initial picture, S, for the sign-bits, using the image generation subsystem 402, is generated as:

$$S [ x , y ] = {sign}_{x , y} * 255 \qquad ( 6 )$$

The initial picture for the exponents, E, using the image generation subsystem 402, is generated as:

$$E [ x , y ] = {exponent}_{x , y} \qquad ( 7 )$$

The initial picture for the mantissas, M, using the image generation subsystem 402, is generated as:

$$M [ x , y ] = {mantissa}_{x , y} >> 15 \qquad ( 8 )$$

where >> is the right bit shift operator. In this case, only the 8 highest significant bits of the mantissa are retained. The remaining bits are quantized out. The three initial pictures, S, E, M, forming the initial image data 403 are each coded according to the PNG image format by the image/video encoder 404 to generate the output coded image data 405. The coded image data 405 is transmitted to a second computing device.

The second computing device receives the coded image data 405/501 and provides this as input to the decoding system 500. The image/video decoder 502 decodes the coded image data 501 according to the PNG image format to produce decoded image data 503 that includes the three pictures. Each picture is then reversed mapped using the parameter decoding subsystem 504 to reconstruct the signs, exponents and mantissas as follows:

$${sign}_{x , y} = round ( S [ x , y ] / 255 ) \qquad ( 9 )$$

$${exponent}_{x , y} = E [ x , y ] \qquad ( 10 )$$

$${mantissa}_{x , y} = M [ x , y ] << 15 \qquad ( 11 )$$

where << is the left bit shift operator.

It will be appreciated that embodiments are not limited to above examples. In addition, whilst the above examples describe encoding/decoding a single layer of weights of a neural network, it will be appreciated that a plurality of layers of weights may be encoded/decoded and/or subsets of parameters may be encoded/decoded. In addition, parameters for other types of machine learning models such as a support vector machine, decision tree, random forest, linear regression, k-means clustering and reinforcement learning system amongst others, may be encoded/decoded other than neural networks.

FIG. 7 shows a schematic illustration of a decoder 10 according to an embodiment. Specifically, FIG. 7 shows a schematic illustration of a decoder 10 configured to perform any of the decoding operations discussed herein. For example, the operations discussed with reference to FIGS. 1, 3 and 5. Such detailed descriptions thereof are omitted here for brevity.

As shown in FIG. 7, the decoder 10 includes a processor 11 and a computer readable medium 12. The processor 11 and the computer readable medium 12 may be connected via a bus system. The computer readable medium is configured to store programs, instructions or codes. The processor 11 is configured to execute the programs, the instructions or the codes in the computer readable medium 12 so as to perform any of the decoding method embodiments disclosed herein.

Hence, in embodiments, the computer readable medium 12 is configured to store a computer program capable of being run in the processor 11, and the processor 11 is configured to run the computer program to perform steps in any of the decoding methods discussed herein.

FIG. 8 shows a schematic illustration of an encoder 20 according to an embodiment. Specifically, FIG. 8 shows a schematic illustration of an encoder 20 configured to perform any of the encoder operations discussed herein. For example, the operations discussed with reference to FIGS. 2, 3, and 4. Such detailed descriptions thereof are omitted here for brevity.

As shown in FIG. 8, the encoder 20 includes a processor 21 and a computer readable medium 22. The processor 21 and the computer readable medium 22 may be connected via a bus system. The computer readable medium is configured to store programs, instructions or codes. The processor 21 is configured to execute the programs, the instructions or the codes in the computer readable medium 22 so as to perform steps in any of the encoding methods discussed herein.

Hence, in embodiments, the computer readable medium 22 is configured to store a computer program capable of being run in the processor 21, and the processor 21 is configured to run the computer program to perform steps in any of the encoding methods discussed herein.

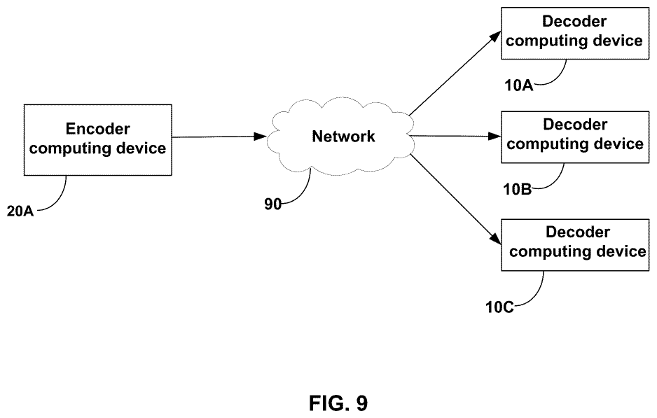

FIG. 9 shows a schematic illustration of a plurality of computing devices connected via a network 90. The plurality of computing devices includes an encoder computing device 20A configured according to the encoder 20 of FIG. 8. The plurality of computing devices further includes decoder computing devices 10A-C configured according to the decoder 10 of FIG. 7. The encoder computing device 20A is configured to represent one or more parameters of a machine learning model as image data and code the image data according to an image or video compression algorithm according to the above described operations. The encoder computing device 20A is configured to transmit the coded image data to one or more of the decoder computing devices 10A-C. The decoder computing devices 10A-C are each configured to decode the coded image data to obtain one or more parameters values for determining one or more parameters of a machine learning model according to the operations described above. Whilst FIG. 9 shows a certain number of encoder and decoder computing devices, it will be appreciated that embodiments are not limited any particular number of encoder or decoder computing devices.

Embodiments can also provide a computer-readable medium having computer-executable instructions to cause one or more processors of a computing device to carry out the method of any of the embodiments.

Examples of computer-readable media include both volatile and non-volatile media, removable and non-removable media, and include, but are not limited to: solid state memories; removable disks; hard disk drives; magnetic media; and optical disks. In general, the computer-readable media include any type of medium suitable for storing, encoding, or carrying a series of instructions executable by one or more computers to perform any one or more of the processes and features described herein.

It will be appreciated that the functionality of each of the components discussed can be combined in a number of ways other than those discussed in the foregoing description. For example, in some embodiments, the functionality of more than one of the discussed devices can be incorporated into a single device. In other embodiments, the functionality of at least one of the devices discussed can be split into a plurality of separate (or distributed) devices.

Conditional language such as “may”, is generally used to indicate that features/steps are used in a particular embodiment, but that alternative embodiments may include alternative features, or omit such features altogether.

Furthermore, the method steps are not limited to the particular sequences described, and it will be appreciated that these can be combined in any other appropriate sequences. In some embodiments, this may result in some method steps being performed in parallel. In addition, in some embodiments, particular method steps may also be omitted altogether.

While certain embodiments have been discussed, it will be appreciated that these are used to exemplify the overall teaching of the present invention, and that various modifications can be made without departing from the scope of the invention. The scope of the invention should is to be construed in accordance with the appended claims and any equivalents thereof.

Many further variations and modifications will suggest themselves to those versed in the art upon making reference to the foregoing illustrative embodiments, which are given by way of example only, and which are not intended to limit the scope of the invention, that being determined by the appended claims.

1. A method for decoding parameters of a machine learning model, performed by a second computing device, the method comprising:
decoding a bitstream to determine values of samples in an image data;
determining one or more parameter values based on the values of the samples in the image data; and
determining one or more parameters of the machine learning model based upon the one or more parameter values.

2. The method of claim 1, wherein determining the one or more parameter values based on the values of the samples in the image data comprises mapping the values of the samples in the image data from a sample value range to a parameter value range.

3. The method of claim 1, wherein determining the one or more parameter values is based upon a bit-depth associated with the image data.

4. The method of claim 1, wherein determining the one or more parameter values based on the values of the samples in the image data comprises:
determining a spatial location of one of the samples in the image data; and
determining one of the parameter values based on the spatial location and the value of the sample in the image data.

5. The method of claim 4, wherein determining one of the parameter values based on the spatial location and the value of the sample in the image date comprises determining one of the parameter values by mapping between the value of one of the samples in the image data and the parameter value based on the spatial location of the sample in the image data.

6. The method of claim 4, wherein determining the spatial location of one of the samples in the image data is based upon a coding block size.

7. The method of claim 1, wherein the one or more parameter values are floating point numbers comprising a sign-bit, an exponent and a mantissa.

8. The method of claim 7, wherein the image data comprises at least one of: a first dedicated picture or channel used for representing the sign-bits of the one or more parameter values; a second dedicated picture or channel used for representing the exponents of the one or more parameter values; or a third dedicated picture or channel used for representing the mantissas of the one or more parameter values.

9. The method of claim 8, wherein determining one or more parameter values based on the values of samples in the image data comprises applying a left bit shift operation to the values of samples of the third dedicated picture or channel.

10. A method for encoding parameters of a machine learning model, performed by a first computing device, the method comprising:
obtaining one or more parameters of a machine learning model;
determining one or more parameter values based on the one or more parameters of the machine learning model;
determining values of samples in an image data based on the one or more parameter values; and
encoding the image data to generate a bitstream.

11. The method of claim 10, wherein determining the values of the samples in the image data based on the one or more parameter values comprises mapping the one or more parameter values from a parameter value range to a sample value range.

12. The method of claim 10, wherein determining the values of the samples in the image data based on the one or more parameter values is based upon a target bit-depth.

13. The method of claim 10, further comprising:
determining a spatial location of one of the samples in the image data, and
determining the values of the samples in the image data based on the one or more parameter values comprises determining a value of the sample in the image data by mapping between the value of the sample in the image data and one of the parameter values based on the spatial location of the sample in the image data.

14. The method of claim 13, wherein determining the spatial location of one of the samples in the image data comprises determining a mapping between the spatial location of the sample in the image data and a parameter index identifying one of the one or more parameters.

15. The method of claim 13, wherein determining the spatial location of one of the samples in the image data is based upon a coding block size.

16. The method of claim 10, wherein the one or more parameters have values that are floating point numbers comprising a sign-bit, an exponent and a mantissa.

17. The method of claim 16, wherein the image data comprises at least one of: a first dedicated picture or channel used for representing the sign-bits of the one or more parameter values; a second dedicated picture or channel used for representing the exponents of the one or more parameter values; or a third dedicated picture or channel that represents the mantissas of the one or more parameter values.

18. The method of claim 17, wherein determining the values of the samples in the image data based on the one or more parameter values comprises applying a right bit shift operation to a mantissa of one of the parameter values.

19. A device for decoding parameters of a machine learning model, comprising:
one or more processors; and
a computer-readable storage medium storing computer executable instructions;
wherein the computer executable instructions, when executed by the one or more processors, cause the one or more processors to:
decode the bitstream to determine values of samples in an image data;
determine the one or more parameter values based on the values of the samples in the image data; and
determine one or more parameters of the machine learning model based upon the one or more parameter values.

20. A non-transitory computer-readable storage medium having computer executable instructions and a bitstream stored thereon, wherein the computer executable instructions, when executed by a computing device, cause the computing device to perform the steps of the method of claim 11 to generate the bitstream.
